(19) United States
(12) Patent Application Publication
(10) Pub. No.: US 2005/0233771 A1
(43) Pub. Date: Oct. 20, 2005

(54) Directional dialing cellular telephone protocol and appurtenances for use therewith

(75) Inventors: Yuval Aflalo, Mazkeret Batia (IL); David Katzir, Reut (IL)

Correspondence Address: JOHN ALEXANDER GALBREATH, 2516 CHESTNUT WOODS CT, REISTERSTOWN, MD, 21136, US

(73) Assignee: Shoot & Talk Ltd., Tel Aviv (IL)

(21) Appl. No.: 10/521,392

(22) PCT Filed: Jul. 14, 2003
(86) PCT No.: PCT/IL03/00583

§ 371 Date: Jan. 15, 2005

(30) Foreign Application Priority Data
Jul. 16, 2002 (IL) 150750

(51) Int. Cl. H04M 1/00

(52) U.S. Cl. 455/562.1; 455/564; 455/550.1

(57) ABSTRACT

Directional dialing cellular telephone protocol, for use within cellular telephone subscriber community substantially sharing data via a mutual common service provider, including: (A) in the subscriber community, user operating modified cellular telephone unit having directional antenna and software application interfaced thereto; (B) in the subscriber community, user operating modified cellular telephone unit having an omni-directional antenna and software application interfaced thereto, and the omni-directional antenna of the user unit configured to receive signals from the other user unit directional antenna; and (C) the protocol has steps of (i) pointing the directional antenna at the other unit, (ii) activating the software application and thereby sending signal from the directional antenna to the omni-directional antenna, (iii) receiving the signal at the omni-directional antenna and thereby activating the software application, and (iv) software application sending acknowledgement to other unit via mutual common service provider.

### FIELD OF THE INVENTION

Generally, the present invention relates to a protocol for use over existing cellular telephone infrastructures. More particularly, the present invention relates to a business method and to a device operating in the context of a protocol of predetermined categories of events occurring via an existing cellular telephone infrastructure.

### BACKGROUND OF THE INVENTION

Location based services in cellular networks generally include such aspects as determining a current cellular location of a known subscriber, an interface with a Global Positioning System (GPS application) or the likes. Nevertheless, there are circumstances where a one cellular telephone subscriber would like to enter into a telecommunications transaction with another such subscriber who is presently in substantial mutual line of sight.

For example, a driver sees a friend in a proximate vehicle. The driver would like to begin a conversation with his friend—but it may not be a facile operation to locate the friend's cellular telephone number while driving. Accordingly, in such circumstances, there is a timely need to facilitate such a conversation in a driver safe way.

Another category of example relates to information signs, such as are often found in airports, train stations, shopping centers, etc. One would like to call the content owner of the sign to conclude an informational transaction without necessarily physically going to visit that owner. A common situation is a sign advertising a sale of an item of merchandise. The passerby would like to query if the item is still available, but the advertiser does not necessarily want to use up valuable advertising space to publish his phone number; nor does the passerby generally want to bother to dial it. Nevertheless, both, parties recognize that they have mutual interest to facilitate the phone call, providing the mechanics of doing so is less bothersome than manually dialing. This scenario is particularly true for a driver observing a roadside billboard. The driver would like a convenient way to contact pursue the media content owner, to inquire about the advertised item, etc.

Another category of example relates to crowded public gathering, such as trade fairs, academic conventions, political conventions, and the likes. Often one would like to strike up a conversation with a heretofore-unknown visitor to such a forum. Essentially, the potential caller knows a few general aspects of a profile that he is looking for. Likewise, the potential recipient is generally agreeable to making public aspects of her profile that might be of interest to a caller. Nevertheless, there is presently no facile method for matching the caller with the probabilistically proximate recipient.

Similarly, a potential recipient, regardless of how interested in active inquiries, would not find the same quality of interest were she to broadcast her profile. In a more refined forum of profile exchange, one would likewise find it preferable for a potential caller and a potential recipient to have a facility to actively participate in some of the negotiation steps of iterative profile disclosure; which is to partially direct an exchange of profile fragments. However, there is presently no facile electronic protocol that integrates physical proximity with profile fragment exchange-management dynamics.

Equivalently, in public places, the management will often find itself in need of a doctor for a visitor, but will be reticent to make a general audio announcement “Is there a Doctor in the house?” The Management would like to discretely conduct its investigation, without causing panic to the public, and nevertheless in a fashion that is facile and probabilistically successful.

Similarly, travelers often desire to find porters without shouting, or diners would like to summon waiters without shouting, or doctors would like to summon assistants without shouting; and all of these circumstances relate to transactions that one desires to initiate in a facile manner according to a discrete parameter of proximity—for which a cellular telephone service provider cell is a large and awkward metric; ill suited to the preferred mode of accomplishing the transaction instantiation—especially if there is simultaneously a partial proximity preference. This shortcoming is better appreciated in central urban location where there are large numbers of potential subscribers in each cell.

In these and other such circumstances, there is a need in the art for a more facile protocol whereby proximate parties may initiate a telecommunications transaction. The need is socially and psychologically longstanding, even if generally heretofore poorly defined and marginally recognized.

### ADVANTAGES, OBJECTS AND BENEFITS OF THE INVENTION

Technical Issues:

The instant invention relates to a telecommunications protocol facilitating a first handshake between two users of cellular telephone type devices. The handshake facilitates other types of cellular telephone services such as a standard telephone calls, an electronic message event, a virtual private network formation, a profile fragment exchange, a micro-payment transfer transactions, or the likes. While the preferred embodiments require integration of a directional antenna into the handshake initiator's unit, other viable embodiments use the existing omni-directional antenna in a quasi-directional emulation mode. Alternative variations require a typical enabled device to be modified to include both an add-on directional antenna (for facilitating directional dialing from the device) and an add-on omni-directional (allowing others to facilitate directional dialing to the device). Nevertheless, there may be cellular telephone devices that allow using an existing pre-integrated omni-directional antenna—and that would be most preferable. Furthermore, for cellular telephone devices enabled with substantially directionally antennas—such as an infra-red antenna—and where in these devices allow using the existing pre-integrated directional antenna for the directional dialing protocol, then the modification of the cellular telephone may be reduced to primarily software modifications.

Ergonomic Issues:

The instant invention facilitates new forms of quasi-anonymous initial social contacts, having novel asymmetric line of sight knowledge aspects. Furthermore, the instant invention facilitates new mercantile media transactions whereby road signs, billboards, marquees, home televisions, and other inert informational media are transformed into facile interactive media.

Economic Issues:

The instant inventions facilitates new revenue streams including micro-payment transactions, new sources for collecting market research statistics, and the likes.

### NOTICES

Numbers, alphabetic characters, and roman symbols are designated in the following sections for convenience of explanations only, and should by no means be regarded as imposing particular order on any method steps. Likewise, the present invention will forthwith be described with a certain degree of particularity, however those versed in the art will readily appreciate that various modifications and alterations may be carried out without departing from either the spirit or scope, as hereinafter claimed.

In describing the present invention, explanations are presented in light of currently accepted Protocol, Telecommunications, Social, Scientific, Technological, or Mercantile theories and models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

### SUMMARY OF THE INVENTION

Essentially, the present invention relates to embodiments of a directional dialing cellular telephone protocol. This protocol is for use within a cellular telephone subscriber community substantially sharing data via at least one mutual common service provider. The instant protocol is generally configured to facilitate a first “handshake” between two users in a mutual service compatible cellular telephone community. The community is preferably made of subscribers that are commonly identified at a central information provider service (CIPS) located within the mutual common service provider infrastructure. Alternatively, the community is made of subscribers having mutual “first handshake” application software in their respective modified cellular telephone units.

The instant protocol includes:
(I) in the subscriber community, a first user operating a modified cellular telephone unit and the unit having a directional antenna interfaced thereto and a first protocol software application interfaced thereto;
(II) in the subscriber community, a second user operating a modified cellular telephone unit and the unit having an omni-directional antenna interfaced thereto and a second protocol software application interfaced thereto, and the omni-directional antenna of the second user unit is configured to receive signals from the directional antenna of the first user unit; and
(III) the protocol has steps of
   (a) pointing the directional antenna of the first unit at the second unit,
   (b) activating the first protocol software application and thereby sending a first signal. from the directional antenna to the omni-directional antenna,
   (c) receiving the first signal at the omni-directional antenna and thereby activating the second protocol software application, and
   (d) the second protocol software application sending an acknowledgement to the first unit via a mutual common service provider.

Simply stated, the signal sent from the directional antenna of the modified cellular telephone of the first user is received by the omni-directional antenna of the cellular telephone of the second user. Application software in the second user's telephone recognizes the signal as being compliant with the instant protocol.

If there is a complete identity fragment in the transmission by the directional antenna, and that fragment includes the phone number of the signal initiator, then the second user may elect to call the initiator back via common carrier.

Alternatively, the second user application may then initiate a transaction with, for example, the “central information provider service (CIPS) located within the mutual common service provider infrastructure” and this transaction will include the identity of the second user and also an identity fragment extracted by the second application from the signal; that was originally transmitted by the directional antenna. According to one simple variation of this scenario, the CIPS may then send a message back to the signal initiator via a mutual common carrier, and the message may include the call back number of the second user. The first user may then elect to call the second user via common carrier.

According to a more sophisticated variation of the instant invention, there may be one or more transmissions of profile information negotiated via the CIPS before the first and second user may mutually agree to establish direct contact; via the common carrier.

According to the preferred variant of the instant invention, it should be appreciated that the near and far field characteristics of the standard omni-directional antenna of the cellular telephone of the first user is substantially a directional antenna, per se. Accordingly, a modification in the cellular telephone of the first user may be a software application modification of the power spectrum applied to the existing antenna. In the context of this modification, the known antenna management is for constant power bursts of signal, while the modified antenna management is for iteratively increasing power bursts beginning at a level which is only receivable at a proximity of a few meters and proceeding iteratively up to about half power level—since it is not an object of the instant protocol to transmit the signal to the service provider for the cell of the first user. The aforesaid iterative heuristic for operation of the standard antenna is also considered as a “directional” antenna, in the context of the instant invention. Nevertheless, it is preferable that the directional antenna should be one that is directional in the near and far field in the ordinary sense of those “proper” notions. Furthermore, the iterative heuristic may be used with the proper antenna, too.

According to another interesting and functionally similar variant of the instant invention, the directional antenna transmission used cellular telephone SMS broadcast mode—thereby illuminating the need for the second unit to be radically modified. The second unit being set to accept SMS broadcast is sufficient to comply with the present invention. Acknowledgement comprises calling the sender back, replying via SMS, or the likes. Furthermore, the directional antenna transmission may be a directional bluetooth formatted transmission, a wireless LAN transmission, or the likes.

According to another preferred class of embodiments, the second user is an informational media such as a notice board at an airport or an advertisement at a shopping center or a municipal information display at a public courtyard. In all of these examples the informational media may be the second user, in that placing a second unit type modified cellular telephone unit proximate to the informational media will facilitate directional dialing to it (and to it's proxy).

For example, an information sign at an international airport may receive a directional dialing signal, electronically extract or negotiate a datum related to the first (caller) user's native language, and arrange to send the user an SMS (GPRS, Data Call, WAP, or the likes) in the user's native language (e.g. a translation of the displayed media content); or arrange for a call to be placed to the user in that language, etc.

### BRIEF DESCRIPTION OF THE FIGURES

In order to understand the invention and to see how it may be carried out in practice, embodiments including the preferred embodiment will now be described, by way of non-limiting example only, with reference to the accompanying drawings, in which:

FIG. 1 illustrates a schematic view of a directional dialing cellular telephone protocol;

FIG. 2 illustrates a schematic view of a directional dialing cellular telephone protocol enabled business method;

FIG. 3 illustrates a schematic view of an article of manufacture; and

FIG. 4 illustrates a schematic view of a non-human second user of a directional dialing cellular telephone protocol.

### DETAILED DESCRIPTION OF THE INVENTION

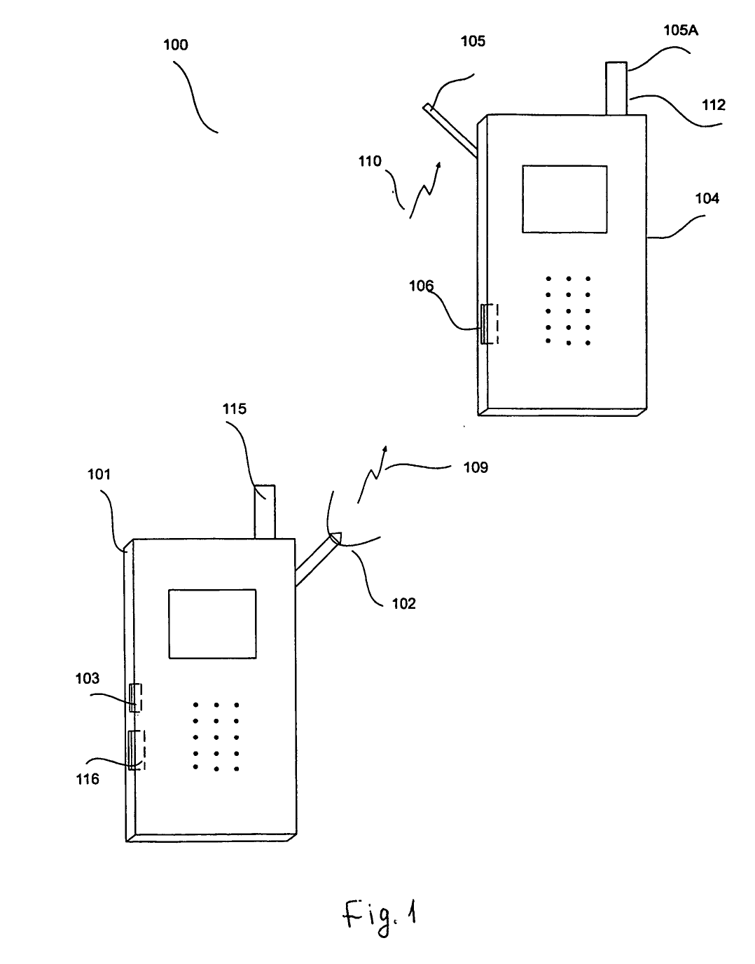

The present invention relates to embodiments of a directional dialing cellular telephone protocol (see FIG. 1), for use within a cellular telephone subscriber community substantially sharing data via at least one mutual common service provider, and the protocol includes: (A) in the subscriber community (100), a first user operating a modified cellular telephone unit (101) and the unit having a directional antenna (102) interfaced thereto and a first protocol software application (103) interfaced thereto; (B) in the subscriber community, a second user operating a modified cellular telephone unit (104) and the unit having an omni-directional antenna (105) interfaced thereto and a second protocol software application (106) interfaced thereto, and the omni-directional antenna of the second user unit is configured to receive signals from the directional antenna of the first user unit; and (C) the protocol has steps of (I) pointing the directional antenna of the first unit at the second unit, (II) activating the first protocol software application and thereby sending (109) a first signal from the directional antenna to the omni-directional antenna, (III) receiving (110) the first signal at the omni-directional antenna and thereby activating the second protocol software application, and (IV) the second protocol software application sending (112) an acknowledgement to the first unit via a mutual common service provider, via an omni-directional antenna (105A).

According to one aspect of the instant embodiment, activating the first protocol includes iterative activation events whereby a first activation event has a predetermined lowest power transmission, and each subsequent activation has a predetermined higher power transmission than its respective predecessor activation event, and the iterative activation events are terminated upon receipt of the acknowledgement. Essentially this is a search mechanism that begins with a small proximate radius to the first user and proceeds until a successful completion has been received or until a predetermined maximum radius for such a search has been reached.

According to another aspect of the instant embodiment, the subscriber community includes a plurality of paying members. In this context the members may use various profile exchange and negotiation routes at the CIPS—both automatic and with critical juncture approval from respective members.

According to a further aspect of the instant embodiment, the members are registered at a data warehousing facility that is accessible via a service provider of the at least one mutual common service provider. In this aspect the profile remains the “property of the user” and release of fragments of information therefrom is at the discretion of the user and in his secure contractual control. It is conceivable that the warehouse may be an out of unit memory extension of his cellular telephone, albeit perhaps resident on his home server.

According to a different aspect of the instant embodiment, the modified cellular telephone unit of the second user is characterized by colorful markings that are visible at a distance. This allows the first user to visually recognize other members of his caller society, club, sect, preference, guild, etc. Likewise, according to another different aspect of the instant embodiment, the modified cellular telephone unit of the second user is characterized by at least one illumination component (such as an LED or fiber optic illuminated antenna, etc. for a handheld unit; or a rotating beacon for a vehicle, road sign, facility marquee, etc.) that is visible at a distance. According to the preferred variation of the present aspect, at least one of the illumination components is modulated; such as by flashing or by optically transmitting a visually recognizable rhythm.

Further, according to a yet another aspect of the instant embodiment, the acknowledgement is via a predetermined media format selected from the list: SMS, GPRS, Data Call, WAP, or the likes. Essentially any format that is inexpensive and nominally secure is sufficient to accomplish the basic first handshake of the instant protocol.

According to still another aspect of the instant embodiment, the acknowledgement includes a mutual common service provider recognizable “telephone number” (e.g. unilateral datum; as opposed to bilateral information packet interchange—described below) associated with the modified cellular telephone unit of the second user. In the context of the heretofore-stated commentary, the transmission of the telephone number as the identity fragment modestly circumvents complicated profile exchange negotiation procedures. Alternatively, the “telephone number” may be other unilateral datum, such as a time stamp and media ID from a dynamic embodiment such as a home television interfaced with a second “type” unit. In this scenario, a viewer observing an interesting advertisement on his TV will point his cell phone at the TV. The second unit cell phone adapted to work with the TV will receive the viewers query, append the time and media ID so as to identify the advertisement, and forward the query to a media coordinator for follow-up; to the viewer's cell phone. In another scenario, the “telephone number” may be a security code or status “report”. For example, a mobile security “service” may be the first user and a commercial “establishment” having intrusion sensors of the “service” may be the second user—and when a member of the “service” points his cell phone at a predetermined location of the premise of the “establishment”, then an intrusion report is embedded in the acknowledgement. In a like scenario, the first user is a food supply service and the second user is a restaurant establishment—so when a mobile member of the service points his cell phone at a predetermined location of the premise of the “establishment”, then a food supply request report is embedded in the acknowledgement according to predetermined data design by the proprietors of the premise.

Now, according to an interesting aspect of the instant embodiment, the acknowledgement spans at least one bilateral information packet interchange. This is the first essential element of a profile exchange negotiation procedure. The content is according to the priority rules of the respective users; and may include an exchange of queries or of answers thereto, or of unilateral disclosures, or of contingent disclosures. According to a first preferred variation of the present aspect, acknowledgment is restricted to a mutually agreeable class of service, and parameters defining classes of service are selected from the list: user rank, user profile component, user affiliation, current activation status, price, and arbitration convention. According to a second preferred variation of the present aspect, the interchange includes at least one datum of information relating to a personal preference of the respective users. According to a third preferred variation of the present aspect, the respective users authorize an accessible data storage facility to release predetermined datum to the respective other user, and the datum is selected from the list: alpha-numeric content, audio content, visual content, multi-media content. Furthermore, in the content of the present third preferred variation, it is in addition preferable that the release is according to at least one respective user specified approval for the release of a next at least one datum.

The present invention also relates to embodiments of a directional dialing cellular telephone protocol enabled device including a modified cellular telephone unit (101) having a directional antenna (102) interfaced thereto and a first protocol software application (103) interfaced thereto and also having an omni-directional antenna (115) interfaced thereto and a second protocol software application (116) interfaced thereto; and the omni-directional antenna is configured to receive signals from a directional antenna operating like (compatible for communications purposes) the directional antenna of the device.

According to one aspect of the instant embodiment, the directional antenna is selected from the list microwave antenna, ultrasound transducer, and infrared transducer; and the omni-directional antenna includes a receiver compatible with the directional antenna.

According to another aspect of the instant embodiment, at least one of the protocol software applications is interfaced to at least one SIM card. In this context the caller ID of the SIM card is a characteristic fragment for use by the CIPS.

According to a further aspect of the instant embodiment, at least one of the protocol software applications is interfaced to at least one supplemental memory media. This supplemental media may be a electronic personal assistant, the home server mentioned above, a flash memory unit, a laptop computer, or the likes.

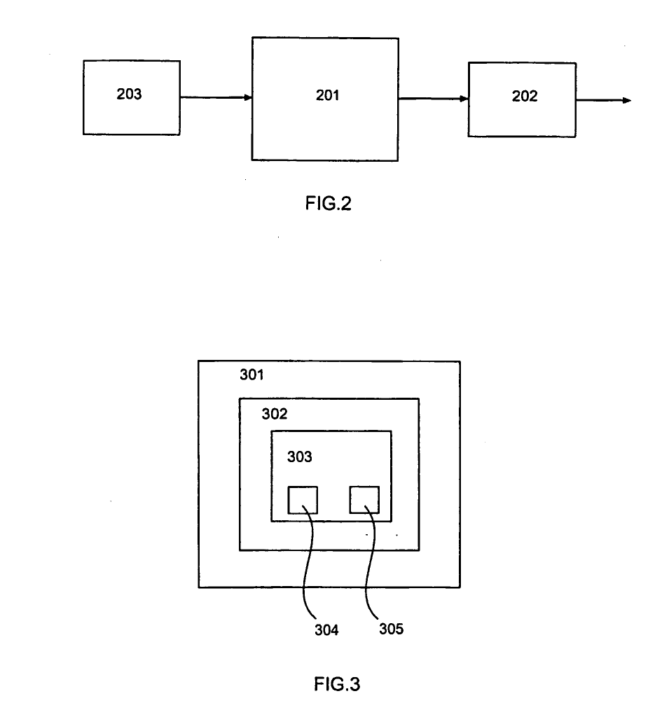

The present invention furthermore relates to embodiments of a directional dialing cellular telephone protocol enabled business method (see FIG. 2) including the steps of first deducting (201) a micro-payment (202) from an account (203) of a user sending a first signal from a directional antenna of a modified cellular telephone unit enabled to operate according to a directional dialing cellular telephone protocol and second deducting (204) a micro-payment (205) from an account (206) of the user receiving an acknowledgement thereto. In this context, an account of a user may be a proxy.

According to an aspect of the instant embodiment, a virtual private network is formed by mutual consent between the sender and a receiver the first signal.

In addition (see FIG. 3), the present invention relates to embodiments of an article of manufacture (301) including a computer usable medium (302) having computer readable program code (303) embodied therein for facilitating mercantile transactions in a directional dialing cellular telephone protocol enabled business method, the computer readable program code in said article of manufacture including: first computer readable program code (304) for transfer—to a first predetermined account—a micro-payment from an account of a user sending a first signal from a directional antenna of a modified cellular telephone unit enabled to operate according to a directional dialing cellular telephone protocol and second computer readable program code (305) for causing the computer to transfer—to a second predetermined account—a micro-payment from an account of the user receiving an acknowledgement thereto.

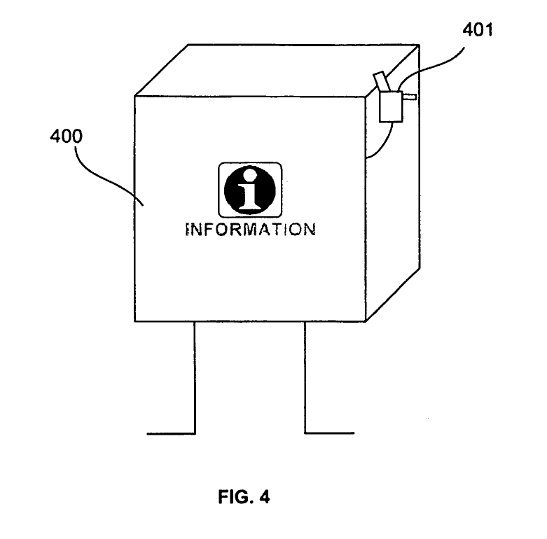

Now, turning to FIG. 4, which illustrates a schematic view of a non-human second user of a directional dialing cellular telephone protocol, on notices that an informational media (400) has a proximate second user type unit (401)—so that a passerby may effectively directionally dial the (proxy application or switchboard operator associated with the) informational media's content

1. A directional dialing cellular telephone protocol, for use within a cellular telephone subscriber community substantially sharing data via at least one mutual common service provider, and the protocol includes:
I) in the subscriber community, a first user operating a modified cellular telephone unit and the unit having a directional antenna interfaced thereto and a first protocol software application interfaced thereto;
II) in the subscriber community, a second user operating a modified cellular telephone unit and the unit having an omni-directional antenna interfaced thereto and a second protocol software application interfaced thereto, and the omni-directional antenna of the second user unit is configured to receive signals from the directional antenna of the first user unit; and
III) the protocol has steps of
a) pointing the directional antenna of the first unit at the second unit,
b) activating the first protocol software application and thereby sending a first signal from the directional antenna to the omni-directional antenna,
c) receiving the first signal at the omni-directional antenna and thereby activating the second protocol software application, and
d) the second protocol software application sending an acknowledgement to the first unit via a mutual common service provider.

2. The directional dialing cellular telephone protocol according to claim 1 wherein activating the first protocol includes iterative activation events whereby a first activation event has a predetermined lowest power transmission, and each subsequent activation has a predetermined higher power transmission than its respective predecessor activation event, and the iterative activation events are terminated upon receipt of the acknowledgement.

3. The directional dialing cellular telephone protocol according to claim 1 wherein the subscriber community includes a plurality of paying members.

4. The directional dialing cellular telephone protocol according to claim 1 wherein the members are registered at a data warehousing facility that is accessible via a service provider of the at least one mutual common service provider.

5. The directional dialing cellular telephone protocol according to claim 1 wherein the modified cellular telephone unit of the second user is characterized by colorful markings that are visible at a distance.

6. The directional dialing cellular telephone protocol according to claim 1 wherein the modified cellular telephone unit of the second user is characterized by at least one illumination component that is visible at a distance.

7. The directional dialing cellular telephone protocol according to claim 6 wherein at least one of the illumination components is modulated.

8. The directional dialing cellular telephone protocol according to claim 1 wherein the acknowledgement is via a predetermined media format selected from the list: SMS, GPRS, Data Call, WAP.

9. The directional dialing cellular telephone protocol according to claim 1 wherein the acknowledgement includes a unilateral datum associated with the second user and the datum is selected from the list: a mutual common service provider recognizable “telephone number” associated with the modified cellular telephone unit of the second user; a time stamp and a media ID; a security code; a status report; and a supply request.

10. The directional dialing cellular telephone protocol according to claim 1 wherein the acknowledgement spans at least one bilateral information packet interchange.

11. The directional dialing cellular telephone protocol according to claim 10 wherein acknowledgment is restricted to a mutually agreeable class of service, and parameters defining classes of service are selected from the list: user rank, user profile component, user affiliation, current activation status, price, and arbitration convention.

12. The directional dialing cellular telephone protocol according to claim 10 wherein the interchange includes at least one datum of information relating to a personal preference of the respective users.

13. The directional dialing cellular telephone protocol according to claim 10 wherein the respective users authorize an accessible data storage facility to release predetermined datum to the respective other user, and the datum is selected from the list: alpha-numeric content, audio content, visual content, multi-media content.

14. The directional dialing cellular telephone protocol according to claim 13 wherein the release is according to at least one respective user specified approval for the release of a next at least one datum.

15. A directional dialing cellular telephone protocol enabled device including a modified cellular telephone unit having a directional antenna interfaced thereto and a first protocol software application interfaced thereto and also having an omni-directional antenna interfaced thereto; and a second protocol software application interfaced thereto.

16. The directional dialing cellular telephone protocol enabled device according to claim 15 wherein the directional antenna is selected from the list microwave antenna, ultrasound transducer, and infrared transducer; and the omni-directional antenna includes a receiver compatible with the directional antenna.

17. The directional dialing cellular telephone protocol enabled device according to claim 15 wherein at least one of the protocol software applications is interfaced to at least one SIM card.

18. The directional dialing cellular telephone protocol enabled device according to claim 15 wherein at least one of the protocol software applications is interfaced to at least one supplemental memory media.

19. A directional dialing cellular telephone protocol enabled business method including the steps of first deducting a micro-payment from an account of a user sending a first signal from a directional antenna of a modified cellular telephone unit enabled to operate according to a directional dialing cellular telephone protocol and second deducting a micro-payment from an account of the user receiving an acknowledgement thereto.

20. The directional dialing cellular telephone protocol enabled business method according to claim 19 wherein a virtual private network is formed by mutual consent between the sender and a receiver the first signal.

21. An article of manufacture including a computer usable medium having computer readable program code embodied therein for facilitating mercantile transactions in a directional dialing cellular telephone protocol enabled business method, the computer readable program code in said article of manufacture including: first computer readable program code for transfer—to a first predetermined account—a micro-payment from an account of a user sending a first signal from a directional antenna of a modified cellular telephone unit enabled to operate according to a directional dialing cellular telephone protocol and second computer readable program code for causing the computer to transfer—to a second predetermined account—a micro-payment from an account of the user receiving an acknowledgement thereto.
